(19) United States
(12) Patent Application Publication
(10) Pub. No.: US 2004/0104492 A1
(43) Pub. Date: Jun. 3, 2004

(54) Carburetor fuel-adjusting device

(75) Inventors: Takumi Nonaka, Iwate-ken (JP); Tamotsu Saito, Aoyama-chou (JP)

Correspondence Address: ORRICK, HERRINGTON & SUTCLIFFE, LLP, 4 PARK PLAZA, SUITE 1600, IRVINE, CA, 92614-2558, US

(73) Assignee: ZAMA JAPAN

(21) Appl. No.: 10/650,901

(22) Filed: Aug. 27, 2003

(30) Foreign Application Priority Data
Oct. 9, 2002 (JP) 2002-295976

(51) Int. Cl. F02M 1/00

(52) U.S. Cl. 261/38; 261/DIG. 52

(57) ABSTRACT

A device in which a needle-shaped valve element of a control valve is inserted into the throttle hole of a fuel channel to adjust the fuel flow rate. Accurate adjustments can be made with a small number of rotations of the control valve. A compensation channel 16 having a metering jet 17 for establishing the minimum required engine flow rate is provided to a valve element 13 of a manual control valve 12 that is inserted in a throttle hole 18 of a primary fuel channel 7. The flow rate is adjusted between the maximum required engine flow rate and the flow rate established by the compensation channel 16 in the gap between the external peripheral surface 13a of the valve element 13 and the entrance edge 18a of the throttle valve 18. Fuel can thereby be adjusted with a small number of rotations of the control valve 12. Accurate fine adjustment can be made with a small number of rotations even when the fine adjustment is achieved by reducing the taper angle of the conical portion 13A.

### FIELD OF THE INVENTION

The present invention relates to a manual fuel-adjusting device advantageous in carburetors for general purpose engines, more particular, a fuel-adjusting device capable of meeting high-level emission standard values.

### BACKGROUND OF THE INVENTION

Only a small quantity of fuel is handled by carburetors that supply fuel to two- or four-cycle general-purpose engines which serve as a power source for small pieces of machinery, small vehicles, and the like. Variation from the set value of the fuel flow rate is created by dimensional errors in all components, deviations in assembly, differences in the quality of components, and the like, unavoidably creating concerns that the air-fuel mixture will become too rich or too lean in comparison with the range compatible with emission regulations.

In view of the above, well-known fuel-adjusting devices cited in U.S. Pat. No. 3,404,872, U.S. Pat. No. 5,236,634, Japanese Patent Publication No. 47-21848, Japanese Utility Model Application Laid-open No. 61-134555, Japanese Patent Application Laid-open No. 6-66205, for example, are provided to carburetors for general-purpose engines.

It is apparent from the references cited above that these well-known fuel-adjusting devices comprise a needle-shaped valve element that is inserted in the throttle valve of the fuel channel and steplessly changes the fuel flow rate, a screw shaft that is threadably inserted in the carburetor main body, and a control valve that comprises a head body for tool engagement exposed on the exterior of the carburetor main body. These components are customarily placed in the fuel channels of a carburetor having a primary fuel system and a low-speed fuel system.

Regulation values continue to become more stringent in emission regulations for general-purpose engines. As a result, the fuel flow rate must be finely adjusted with a control valve in response to variation in the engine as well as variation in the carburetor itself.

In view of the above, reducing the screw pitch of the screw shaft more than normal, or reducing the taper angle of the valve element more than normal may be considered in the research and design stages as a means of providing fine adjustment function for the fuel flow rate to the control valve, and fine adjustment may be accurately performed because the fuel flow rate change for one rotation of the control valve is small with these countermeasures.

However, devices wherein the screw pitch of the screw shaft is reduced more than normal are troublesome because initial adjustment and later readjustments require several rotations. Reducing the taper angle of the valve element not only results in elongating the control valve as a whole because the stroke across the entire adjustment range is large, but the same drawback also occurs as when the screw pitch is made smaller, namely, initial adjustments and later major readjustments require several rotations.

### SUMMARY OF THE INVENTION

The present invention provides a solution to the problems described above; namely, to reduce the taper angle of the valve element and the screw pitch of the screw shaft in order to provide fine adjustment function to control valves. An objective thereof is to provide a control valve that allows precise initial adjustment with a small number of rotations and that is additionally capable of easily and accurately making readjustments.

In the present invention, the above-described problems of a carburetor fuel-adjusting device comprising a control valve that has a needle-shaped valve element at the leading end, is threadably inserted into the carburetor main body, is manually operated from the exterior, has a throttle hole that is formed in a fuel channel which reaches the air intake channel from the constant fuel chamber, and is capable of steplessly changing the fuel flow rate in cooperation with the valve element, are addressed by providing the valve element with a compensation channel that has a metering jet for introducing fuel flowing from the constant fuel chamber and for allowing an engine minimum required flow rate to be discharged into the throttle hole.

In the state in which the control valve is threadably inserted to the maximum limit and the throttle hole is sealed by the valve element, fuel flows at the minimum rate required by the engine. In other words, fuel passes through the compensation channel at a flow rate that establishes the lean-side limit of the air-fuel mixture, and is sent to the suction channel. When the valve element is thereafter retracted, the gap between the entrance edge of the throttle hole and the conical external peripheral surface is increased, and the fuel that passes through this gap is added to the fuel that passed through the compensation channel, resulting in an adjustment to the fuel flow rate. Fuel adjustment is started from a state in which the minimum fuel flow rate is assured, so the valve element stroke required up to the maximum flow rate is short even if the taper angle is reduced, the initial adjustment can therefore be performed with a small number of rotations, and readjustments can be easily and accurately performed.

### BRIEF DESCRIPTION OF THE DRAWINGS

FIG. 1 is a longitudinal schematic section showing an embodiment of the present invention.

FIG. 2 is an enlarged section cutaway view of FIG. 1.

### DESCRIPTION OF THE PREFERRED EMBODIMENTS

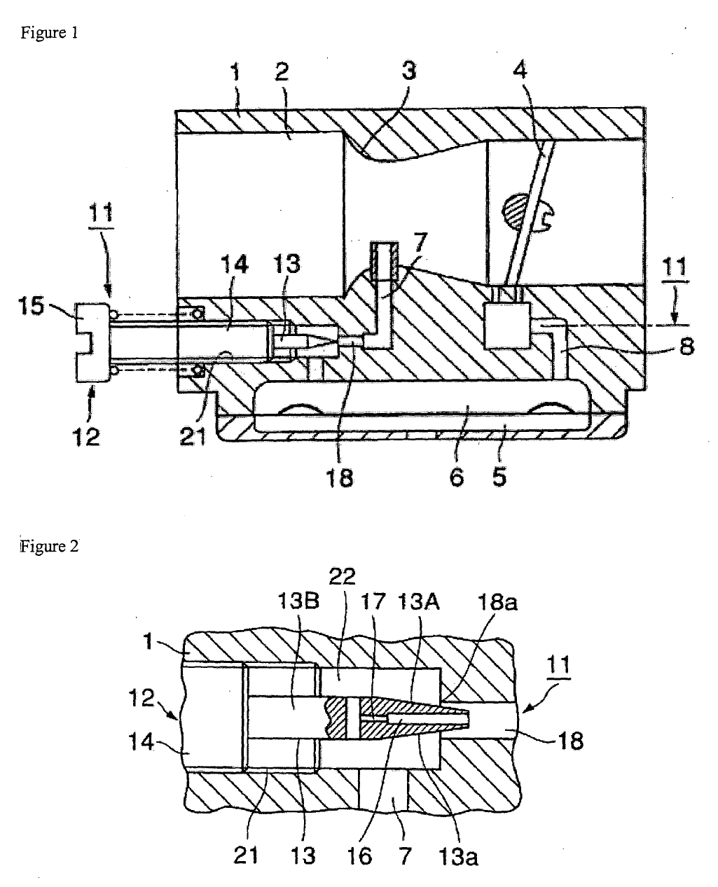

An embodiment of the present invention is described with reference to the diagrams. FIG. 1 is a longitudinal section schematically depicting an example of a carburetor comprising the fuel-adjusting device of the present invention. A constant fuel chamber 6, which is sectioned off from the atmosphere by a diaphragm 5, is disposed on the bottom surface of a carburetor main body 1 that has a suction channel 2 extending in the transverse direction. Fuel, which is adjusted to a fixed quantity by a fuel valve (not depicted) in response to the diaphragm 5 and stored in the constant fuel chamber 6, passes through a primary fuel channel 7 and is delivered to the narrowest portion of a venturi tube 3, or passes through a low-speed fuel channel 8 and is delivered to the sides of the throttle valve.

The fuel-adjusting device 11 related to the present invention is disposed in both the primary fuel channel 7 and the low-speed fuel channel 8 in the well-known membrane-type carburetor described above. These two fuel-adjusting devices 11 are essentially the same, so the device for the low-speed fuel channel 8 is omitted in FIG. 1.

An embodiment of the fuel-adjusting device 11 is described with reference to FIGS. 1 and 2. In the control valve 12, the leading end is a conical portion 13A, and the base end is shaped as the axle portion 13B with a uniform diameter. The entire valve comprises a needle-shaped valve 13, a screw shaft 14, and a head body 15 for tool engagement. The valve is configured such that a screw shaft 14 is threadably inserted into the screw hole 21 of the carburetor main body 1, and a throttle element 13 is inserted into the valve chamber 22 formed partway along the primary fuel channel 7. By engaging a tool in the head body 15 that protrudes to the exterior of the carburetor main body 1 and rotating the screw shaft 14, the conical portion 13A is caused to reciprocate between the position in which the external peripheral surface 13a makes contact with the entrance edge 18a of the throttle hole 18 formed forward of the valve chamber 22 and seals the throttle hole 18, and the position in which the leading end is completely removed and the throttle hole 18 is completely open.

The valve element 13 has a compensation channel 16 with one end opened on the external peripheral surface of the axle portion 13B and the other end opened on the leading end surface of the conical portion 13A, and a metering jet 17 disposed in the compensation channel 16 for setting the minimum required flow rate of the engine, in other words, the lean-side limit of the air-fuel mixture.

When mounted in an engine and initially adjusted, the control valve 12 is first threadably inserted to the maximum limit, and the throttle hole 18 is sealed by bringing the external peripheral surface 13a of the conical portion 13A into contact with the entrance edge 18a of the throttle hole 18. As a result, the fuel in the constant fuel chamber 6 enters the compensation channel 16 from the valve chamber 22, and only fuel at a flow rate metered by the metering jet 17 is supplied to the engine.

By turning the control valve 12 in the direction which removes the conical portion 13A from the throttle hole 18 to form a gap between the external peripheral surface 13a and the entrance edge 18a, fuel from the valve chamber 22 is caused to flow through the gap and is supplied to the engine, and the air-fuel mixture transitions from the lean-side limit to the rich side. Operation of the control valve 12 is ceased when the air-fuel mixture reaches a value in which both a predetermined air-fuel ratio, in other words, engine operability, and a value that meets exhaust regulations are achieved.

According to the present embodiment, the minimum flow rate is maintained by the compensation channel 16. The required fuel flow rate can be obtained by changing the size of the gap between the external peripheral surface 13a and the entrance edge 18a and adjusting the added flow rate. The required adjustment is performed by merely rotating the control valve 12 a small number of times.

According to the present invention, even if the taper angle of the conical portion 13A is reduced and the quantity of change in the size of the gap for each rotation, in other words, the change in fuel flow rate, is reduced to be able to precisely perform fine adjustments, adjustment is performed between the flow rate provided by the compensation channel 16 and the maximum required flow rate of the engine, and can therefore be made without significantly increasing the number of rotations and without greatly lengthening the conical portion 13A.

The present embodiment entails providing a metering jet 17 for assuring a minimum flow rate in the same channel as the primary fuel channel 7, which reaches the suction channel 2 from the constant fuel chamber 6, and also providing a throttle element 13/throttle hole 18 assembly for adjusting the fuel flow rate added thereto. Since there is no need to provide a separate channel, fuel with an adjusted flow rate can be supplied with good stability without the drawback of creating an imbalance in the pressures exerted on these components and of producing a flow ratio that deviates during variations in the pressure of the constant fuel chamber 6 and the suction channel 2. Also, the metering jet 17 is disposed inside the valve element 13, so an advantage is obtained in that the overall structure is simple and compact.

The fuel-adjusting device 11 disposed in the low-speed fuel channel 8 is the same device as described above, so a description thereof is omitted.

According to the present invention, as described above, not only can the fuel flow rate be accurately adjusted with simple operation in the sense that the control valve is turned a small number of times, but fine adjustment can also be easily and accurately performed. These adjustments can be easily made to meet exhaust regulations and to adjust the fuel flow rate in response to changes in the engine service environment and changes in engine performance over time.

What is claimed is:

1. A carburetor fuel-adjusting device, comprising
a control valve having a needle-shaped valve element at a leading end, is threadably inserted into a carburetor main body, and is manually operated from the exterior,
a throttle hole that is formed in a fuel channel which reaches an air intake channel from a constant fuel chamber, and that is capable of steplessly changing the fuel flow rate in cooperation with the valve element, and
a compensation channel with a metering jet provided to the valve element for introducing fuel flowing from a constant fuel chamber and for allowing an engine minimum required flow rate to be discharged into the throttle hole.

2. The carburetor fuel-adjusting device according to claim 1, wherein the jet sets the lean-side limit of the air-fuel mixture when the throttle element closes the throttle hole.

3. The carburetor fuel-adjusting device according to claim 1, wherein the compensation channel adjusts the fuel flow rate by keeping fuel at the lean-side limit of the air-fuel mixture and adding to this fuel the portion of fuel that passes through the gap between the conical external peripheral surface of the valve element and the entrance edge of the throttle hole.

4. A carburetor fuel-adjusting device, comprising
a constant fuel chamber,
a fuel channel,
a throttle valve in fluid communication with the constant fuel chamber and the fuel channel,
a compensation channel in the throttle valve connecting the constant fuel chamber to the fuel channel, and
a metering jet disposed in the compensation channel.

5. The carburetor fuel-adjusting device of claim 4 wherein the throttle valve comprises a needle shaped valve element.

6. The carburetor fuel-adjusting device of claim 4 further comprising a throttle hole.

7. The carburetor fuel-adjusting device of claim 6 wherein the compensation channel allows an engine minimum required flow rate to be discharged into the throttle hole.

8. The carburetor fuel-adjusting device of claim 7 wherein the throttle hole is capable of steplessly adjusting the fuel rate.

9. The carburetor fuel-adjusting device of claim 4 wherein the throttle valve is manually operated.

10. The carburetor fuel-adjusting device of claim 9 wherein the throttle valve is operated from the exterior.

11. The carburetor fuel-adjusting device of claim 8 wherein the throttle valve is manually operated.

12. The carburetor fuel-adjusting device of claim 11 wherein the throttle valve is operated from the exterior.

13. The carburetor fuel-adjusting device of claim 5 wherein the throttle valve is manually operated.

14. The carburetor fuel-adjusting device of claim 13 wherein the throttle valve is operated from the exterior.

15. The carburetor fuel-adjusting device according to claim 5, wherein the metering jet sets the lean-side limit of an air-fuel mixture when the throttle element closes the throttle hole.

16. The carburetor fuel-adjusting device according to claim 5, wherein the compensation channel adjusts a fuel flow rate by keeping fuel at the lean-side limit of an air-fuel mixture and adding to this fuel a portion of fuel that passes through a gap between a conical external peripheral surface of the valve element and an entrance edge of the throttle hole.

17. A carburetor fuel-adjusting device, comprising
a constant fuel chamber,
a fuel channel,
a throttle valve comprised of a valve element and a throttle hole in fluid communication with the constant fuel chamber and the fuel channel,
a compensation channel running through the valve element from the constant fuel chamber into the throttle hole, and
a metering jet disposed in the compensation channel.

18. The carburetor fuel-adjusting device of claim 17 wherein the valve element is needle shaped.

19. The carburetor fuel-adjusting device of claim 17 wherein the throttle valve is manually adjustable.

20. The carburetor fuel-adjusting device of claim 18 wherein the valve is operated from the exterior.

21. The carburetor fuel-adjusting device of claim 17 wherein the compensation channel allows an engine minimum required flow rate to be discharged into the throttle hole.

22. The carburetor fuel-adjusting device of claim 17 wherein the throttle hole is capable of steplessly adjusting the fuel rate.

23. The carburetor fuel-adjusting device according to claim 17, wherein the metering jet sets the lean-side limit of an air-fuel mixture when the throttle element closes the throttle hole.

24. The carburetor fuel-adjusting device according to claim 17, wherein the compensation channel adjusts a fuel flow rate by keeping fuel at the lean-side limit of an air-fuel mixture and adding to this fuel a portion of fuel that passes through a gap between a conical external peripheral surface of the valve element and an entrance edge of the throttle hole.
